(19) United States
(12) Patent Application Publication
(10) Pub. No.: US 2023/0412316 A1
(43) Pub. Date: Dec. 21, 2023

(54) HARQ TIMING FOR DCI SCHEDULING MULTIPLE CELLS

(71) Applicant: TELEFONAKTIEBOLAGET LM ERICSSON (PUBL), Stockholm (SE)

(72) Inventors: Ajit Nimbalker, DUBLIN, CA (US); Ravikiran Nory, SAN JOSÉ, CA (US); Robert Baldemair, SOLNA (SE); Petter Ersbo, KNIVSTA (SE); Zhanxian Wang, TÄBY (SE)

(21) Appl. No.: 18/032,144

(22) PCT Filed: Oct. 14, 2021
(86) PCT No.: PCT/IB2021/059475

§ 371 Date: Apr. 14, 2023

Related U.S. Application Data
(60) Provisional application No. 63/091,699, filed on Oct. 14, 2020.

(51) Int. Cl. H04L 1/1829; H04W 72/232; H04W 72/1273

(52) U.S. Cl. CPC H04L 1/1854; H04W 72/232; H04W 72/1273

(57) ABSTRACT

Systems and methods related to Hybrid Automatic Repeat Request (HARQ) timing for Downlink Control Information (DCI) scheduling multiple cells are disclosed. In one embodiment, a method performed by a wireless communication device comprises receiving, from a base station, a DCI that schedules downlink transmissions to the wireless communication 5 device on two or more serving cells. The method further comprises receiving and decoding the downlink transmissions on the two or more serving cells scheduled by the DCI. The method further comprises determining a slot in which to transmit HARQ feedback for the downlink transmissions on the two or more serving cells scheduled by the DCI based on a single HARQ feedback timing indicator comprised in the DCI and a reference timing and transmitting, to the 0 base station, HARQ feedback for the downlink transmissions on the two or more serving cells scheduled by the DCI in the determined slot.

### RELATED APPLICATIONS

This application claims the benefit of U.S. Provisional Patent Application No. 63/091,699, filed Oct. 14, 2020, the disclosure of which is hereby incorporated herein by reference in its entirety.

### TECHNICAL FIELD

The present disclosure relates to Hybrid Automatic Repeat Request (HARQ) feedback timing in a wireless network.

### BACKGROUND

In Third Generation Partnership Project (3GPP) New Radio (NR) Releases 15 and 16, one Downlink Control Information (DCI) schedules a Physical Downlink Shared Channel (PDSCH) on one cell only. The DCI format which is carried on a Physical Downlink Control Channel (PDCCH) typically includes information about the downlink scheduling such as New Data Indictor (NDI), Modulation and Coding Scheme (MCS), Frequency Domain Resource Allocation (FDRA), Redundancy Version (RV), Multiple-Input Multiple-Output (MIMO) information (number of layers, scrambling code, etc.), and time domain resource allocation that includes a slot and length indicator value (SLIV). The DCI format also includes information about the uplink resources on which the Hybrid Automatic Repeat Request (HARQ) feedback information can be transmitted by the User Equipment (UE). This can also include the PDSCH-to-HARQ_feedback timing indicator field, the Physical Uplink Control Channel (PUCCH) resource index, power control commands, etc. The HARQ feedback can be carried on the PUCCH or Physical Uplink Shared Channel (PUSCH) on a primary cell (PCell), or a PUCCH on a secondary cell (SCell).

Since NR supports carrier aggregation with multiple numerologies, the slots where PUCCH transmissions would occur are used as reference to identify the HARQ feedback timing. If the UE detects a downlink (DL) DCI scheduling a PDSCH reception ending in slot n, the UE provides HARQ-ACK information in a PUCCH transmission within slot n+k, where k is indicated by the PDSCH-to-HARQ_feedback timing indicator field in the DCI format. Here, k=0 corresponds to the last slot of the PUCCH transmission that overlaps with the PDSCH reception. A corresponding excerpt from 3GPP Technical Specification (TS) 38.213 (see 38.213-fa0) is shown below.
With reference to slots for PUCCH transmissions, if the UE detects a DCI format 1_0 or a DCI format 1_1 scheduling a PDSCH reception ending in slot n or if the UE detects a DCI format 1_0 indicating a SPS PDSCH release through a PDCCH reception ending in slot n, the UE provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK. k=0 corresponds to the last slot of the PUCCH transmission that overlaps with the PDSCH reception or with the PDCCH reception in case of SPS PDSCH release.

An example of HARQ feedback timing for DCI scheduling PDSCH on single cells in the case of Carrier Aggregation (CA) is shown in FIG. 1. In this example, the UE is configured with two serving cells. The Primary Cell (PCell) is a Frequency Division Duplexing (FDD) cell with 15 kilohertz (kHz) subcarrier spacing (SCS) (and slot duration of 1 millisecond (ms)), and the Secondary Cell (SCell) can be a Time Division Duplexing (TDD) cell with 30 kHz SCS (and a slot duration of 0.5 ms). Both PCell and SCell are self-scheduled. The control on PCell (dci1) schedules a PDSCH on the PCell (pdsch1), and the control also includes PDSCH-to-HARQ_feedback timing indicator field in the DCI format (k1_{dci1}=2), implying the feedback is transmitted two slots later (in PUCCH numerology), denoted by pucch1. The control on SCell (dci2) schedules a PDSCH on the SCell (pdsch2), and the control also includes PDSCH-to-HARQ_feedback timing indicator field in the DCI format (k1_{dci2}=2), implying the feedback is transmitted two slots later (in PUCCH numerology), denoted by pucch2. Here, the slot where pdsch2 ends (in PUCCH numerology), i.e. slot n+1, is used as reference to identify the slot where pucch2 is transmitted, i.e. n+1+k1_{dci2}=n+3.

### SUMMARY

Systems and methods related to Hybrid Automatic Repeat Request (HARQ) timing for Downlink Control Information (DCI) scheduling multiple cells are disclosed. In one embodiment, a method performed by a wireless communication device for a cellular communications system comprises receiving, from a base station, a DCI that schedules downlink transmissions to the wireless communication device on two or more serving cells of the wireless communication device. The method further comprises receiving and decoding the downlink transmissions on the two or more serving cells scheduled by the DCI. The method further comprises determining a slot in which to transmit HARQ feedback for the downlink transmissions on the two or more serving cells scheduled by the DCI based on a single HARQ feedback timing indicator comprised in the DCI and a reference timing and transmitting, to the base station, HARQ feedback for the downlink transmissions on the two or more serving cells scheduled by the DCI in the determined slot. In this manner, efficient scheduling of PDSCH on multiple cells using a single DCI is provided, with a clear and unambiguous HARQ feedback timing.

In one embodiment, the reference timing is a slot in which one of the downlink transmissions that is scheduled for a reference cell ends. In one embodiment, the reference cell is one of the two or more serving cells for which the DCI schedules the downlink transmissions. In one embodiment, the reference cell is configured by a base station in the cellular communications system. In one embodiment, the method further comprises receiving, from the base station, information that configures the reference cell. In one embodiment, receiving the information that configures the reference cell comprise receiving the information that configures the reference cell via higher layer signaling. In another embodiment, the reference cell is predefined. In another embodiment, the reference cell is one of the two or more serving cells on which the wireless communication device receives the DCI. In another embodiment, the reference cell is one of the two or more serving cells for which the DCI schedules the downlink transmissions that has a lowest cell index from among cell indices of the two or more serving cells. In another embodiment, the reference cell is one of the two or more serving cells for which the DCI schedules the downlink transmissions that has a highest cell index from among cell indices of the two or more serving cells. In another embodiment, the reference cell is one of the two or more serving cells for which the DCI schedules the downlink transmissions selected as a function of cell indices of the two or more serving cells.

In one embodiment, the determined slot is slot X+Y, where X is the slot in which one of the downlink transmissions that is scheduled for a reference cell ends and Y is a number of slots indicated by the single HARQ feedback timing indicator comprised in the DCI.

In one embodiment, the reference cell is one of the two or more serving cells for which the DCI schedules the downlink transmissions defined by a position in which corresponding scheduling information occurs in the DCI.

In one embodiment, the reference timing is a reference slot. In one embodiment, the reference slot is a slot in which a last-ending downlink transmission from among the downlink transmissions scheduled by the DCI ends. In one embodiment, the reference slot is counted according to a numerology of one of the two or more serving cells that carries the last-ending downlink transmission. In one embodiment, the determined slot is slot X+Y, where X is the reference slot and Y is a number of slots indicated by the single HARQ feedback timing indicator comprised in the DCI.

In one embodiment, the downlink transmissions are Physical Downlink Shared Channels (PDSCHs).

In one embodiment, at least two of the two or more serving cells use different numerologies.

Corresponding embodiments of a wireless communication device for a cellular communications system are also disclosed. In one embodiment, a wireless communication device for a cellular communications system is adapted to receive, from a base station, a DCI that schedules downlink transmissions to the wireless communication device on two or more serving cells of the wireless communication device. The wireless communication device is further adapted to receive and decode the downlink transmissions on two or more serving cells scheduled by the DCI. The wireless communication device is further adapted to determine a slot in which to transmit HARQ feedback for the downlink transmissions on two or more serving cells scheduled by the DCI based on a single HARQ feedback timing indicator comprised in the DCI and a reference timing and transmit, to the base station, HARQ feedback for the downlink transmissions on two or more serving cells scheduled by the DCI in the determined slot.

In one embodiment, a wireless communication device for a cellular communications system comprises one or more transmitters, one or more receivers, and processing circuitry associated with the one or more transmitters and the one or more receivers. The processing circuitry is configured to cause the wireless communication device to receive, from a base station, a DCI that schedules downlink transmissions to the wireless communication device on two or more serving cells of the wireless communication device. The processing circuitry is further configured to cause the wireless communication device to receive and decode the downlink transmissions on two or more serving cells scheduled by the DCI. The processing circuitry is further configured to cause the wireless communication device to determine a slot in which to transmit HARQ feedback for the downlink transmissions on two or more serving cells scheduled by the DCI based on a single HARQ feedback timing indicator comprised in the DCI and a reference timing and transmit, to the base station, HARQ feedback for the downlink transmissions on two or more serving cells scheduled by the DCI in the determined slot.

Embodiments of a method performed by a base station for a cellular communications system are also disclosed. In one embodiment, a method performed by a base station for a cellular communications system comprises transmitting, to a wireless communication device, a DCI that schedules downlink transmissions to the wireless communication device on two or more serving cells of the wireless communication device, the DCI comprising a single HARQ feedback timing indicator. The method further comprises receiving, from the wireless communication device, HARQ feedback for the downlink transmissions on two or more serving cells scheduled by the DCI in a particular slot, wherein the particular slot is defined based on the single HARQ feedback timing indicator comprised in the DCI and a reference timing.

In one embodiment, the reference timing is a slot in which one of the downlink transmissions that is scheduled for a reference cell ends. In one embodiment, the reference cell is one of the two or more serving cells for which the DCI schedules the downlink transmissions. In one embodiment, the reference cell is configured by the base station in the cellular communications system. In one embodiment, the method further comprises transmitting, to the wireless communication device, information that configures the reference cell. In one embodiment, transmitting the information that configures the reference cell comprise transmitting the information that configures the reference cell via higher layer signaling. In another embodiment, the reference cell is predefined. In another embodiment, the reference cell is one of the two or more serving cells on which the wireless communication device receives the DCI. In another embodiment, the reference cell is one of the two or more serving cells for which the DCI schedules the downlink transmissions that has a lowest cell index from among cell indices of the two or more serving cells. In another embodiment, the reference cell is one of the two or more serving cells for which the DCI schedules the downlink transmissions that has a highest cell index from among cell indices of the two or more serving cells. In another embodiment, the reference cell is one of the two or more serving cells for which the DCI schedules the downlink transmissions selected as a function (e.g., a predefined function) of cell indices of the two or more serving cells.

In one embodiment, the particular slot is slot X+Y, where X is the slot in which one of the downlink transmissions that is scheduled for a reference cell ends and Y is a number of slots indicated by the single HARQ feedback timing indicator comprised in the DCI.

In one embodiment, the reference timing is a reference slot. In one embodiment, the reference slot is a slot in which a last-ending downlink transmission from among the downlink transmissions scheduled by the DCI ends. In one embodiment, the reference slot is counted according to a numerology of one of the two or more serving cells that carries the last-ending downlink transmission. In one embodiment, the particular slot is slot X+Y, where X is the reference slot and Y is a number of slots indicated by the single HARQ feedback timing indicator comprised in the DCI.

In one embodiment, the downlink transmissions are PDSCHs.

In one embodiment, at least two of the two or more serving cells use different numerologies.

Corresponding embodiments of a base station for a cellular communications system are also disclosed. In one embodiment, a base station for a cellular communications system is adapted to transmit, to a wireless communication device, a DCI that schedules downlink transmissions to the wireless communication device on two or more serving cells of the wireless communication device, the DCI comprising a single HARQ feedback timing indicator. The base station is further adapted to receive, from the wireless communication device, HARQ feedback for the downlink transmissions on two or more serving cells scheduled by the DCI in a particular slot, wherein the particular slot is defined based on the single HARQ feedback timing indicator comprised in the DCI and a reference timing.

In one embodiment, a base station for a cellular communications system comprises processing circuitry configured to cause the base station to transmit, to a wireless communication device, a DCI that schedules downlink transmissions to the wireless communication device on two or more serving cells of the wireless communication device, the DCI comprising a single HARQ feedback timing indicator. The processing circuitry is further configured to cause the base station to receive, from the wireless communication device, HARQ feedback for the downlink transmissions on two or more serving cells scheduled by the DCI in a particular slot, wherein the particular slot is defined based on the single HARQ feedback timing indicator comprised in the DCI and a reference timing.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates an example of Hybrid Automatic Repeat Request (HARQ) feedback timing for Downlink Control Information (DCI) scheduling Physical Downlink Shared Channel (PDSCH) on single cells in the case of Carrier Aggregation (CA);

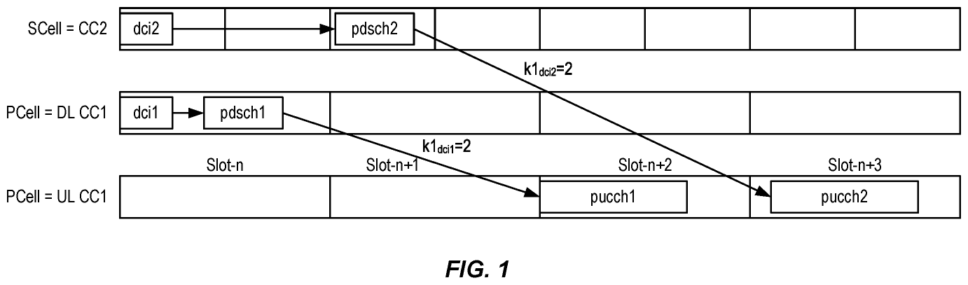

FIG. 2 illustrates an example of HARQ feedback timing ambiguity for DCI scheduling PDSCH on multiple cells and with a single PDSCH-to-HARQ_feedback timing indicator field in the DCI format;

FIG. 3 illustrates one example of a cellular communications system in which embodiments of the present disclosure may be implemented;

FIG. 4 illustrates an example of DCI scheduling PDSCH on multiple cells;

FIG. 5 illustrates an example of an embodiment of the present disclosure in which HARQ feedback timing for HARQ feedback for multiple PDSCH transmissions on multiple cells scheduled by a single DCI is determined based on a single PDSCH-to-HARQ feedback timing indicator comprised in the DCI and a reference timing related to the PDSCH transmission on a reference cell;

FIG. 6 illustrates another example of an embodiment of the present disclosure in which HARQ feedback timing for HARQ feedback for multiple PDSCH transmissions on multiple cells scheduled by a single DCI is determined based on a single PDSCH-to-HARQ feedback timing indicator comprised in the DCI and a reference timing related to the PDSCH transmission on a reference cell;

FIG. 7 illustrates another example of an embodiment of the present disclosure in which HARQ feedback timing for HARQ feedback for multiple PDSCH transmissions on multiple cells scheduled by a single DCI is determined based on a single PDSCH-to-HARQ feedback timing indicator comprised in the DCI and a reference slot which is the slot in which the last-ending PDSCH of the multiple PDSCHs scheduled by the DCI ends;

FIG. 8 illustrates the operation of a wireless communication device and a base station in accordance with at least some aspects of the embodiments described herein;

FIGS. 9, 10, 11 are schematic block diagrams of example embodiments of a radio access node (e.g., a base station);

FIGS. 12 and 13 are schematic block diagrams of example embodiments of a wireless communication device;

FIG. 14 illustrates an example embodiment of a communication system in which embodiments of the present disclosure may be implemented;

FIG. 15 illustrates example embodiments of the host computer, base station, and UE of FIG. 14; and

FIGS. 16 and 17 are flow charts that illustrate example embodiments of methods implemented in a communication system such as that of FIG. 14.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

There current exist certain challenge(s) with respect to Hybrid Automatic Repeat Request (HARQ) timing in a 3GPP network such as, e.g., a NR network. A UE can be configured with multiple cells. For a cell of the multiple cells, the UE can be configured to monitor one or more Downlink Control Information (DCI) scheduling a single cell and to monitor one or more DCI scheduling multiple cells. In DCI scheduling multiple cells, only a portion of the DCI may contain scheduling information relevant for each cell, and a single HARQ feedback indicator may be used. In such a case, the Physical Downlink Shared Channel (PDSCH) HARQ timing can become ambiguous. The DCI scheduling PDSCH on multiple cells can be addressed to Cell Radio Network Temporary Identifier (C-RNTI), Modulation and Coding Scheme Cell Radio Network Temporary Identifier (MCS-C-RNTI), or Semi-Persistent Scheduling Cell Radio Network Temporary Identifier (SPS-C-RNTI) (which in NR may be referred as CS-RNTI or configured scheduling RNTI).

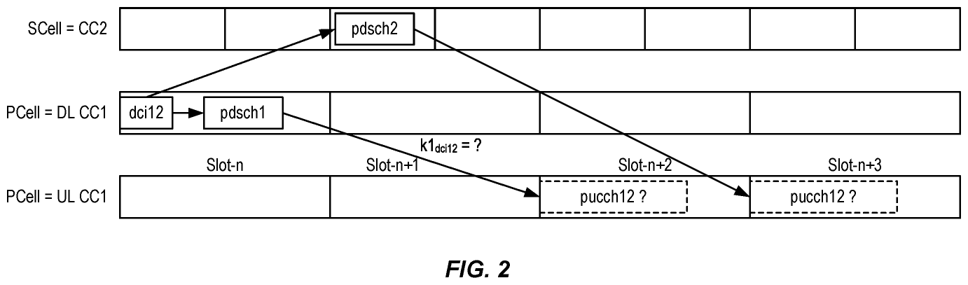

In this regard, FIG. 2 illustrates an example of HARQ feedback timing ambiguity for DCI scheduling PDSCH on multiple cells and with a single PDSCH-to-HARQ_feedback timing indicator field in the DCI format. Assume that the Primary Cell (PCell) is self-scheduled and the Secondary Cell (SCell) is cross-carrier scheduled from the PCell. Moreover, a single control on PCell (dci12) schedules a PDSCH on the PCell (pdsch1) and schedules a PDSCH on the SCell (pdsch2), and the control also includes PDSCH-to-HARQ_feedback timing indicator field in the DCI format (k1_{dci12}). The reference for Physical Uplink Control Channel (PUCCH) (pucch12) transmission becomes unclear as following current 3GPP specifications would imply pucch12 is transmitted in two different slots (based on timing of pdsch1 and pdsch2).

Thus, there currently exist certain challenge(s) in that HARQ feedback timing is defined relative to the slot in which PDSCH ends. For single DCI scheduling PDSCH on multiple cells, HARQ feedback timing can becomes ambiguous, particularly when multiple PDSCHs end at different times or in different slots.

Certain aspects of the present disclosure and their embodiments may provide solutions to the aforementioned or other challenges. For single DCI scheduling PDSCH on multiple cells, an unambiguous reference for HARQ feedback timing is defined or configured using one of the following options:
1) one of the cells is configured or defined as a reference cell, and the HARQ feedback timing is defined relative to the slot in which PDSCH of the reference cell ends, or
2) the slot corresponding to the end of the PDSCH (of the multiple PDSCHs) which ends last (or first, even though last is preferred) is used as the reference cell for HARQ feedback timing.

Certain embodiments may provide one or more of the following technical advantage(s). Solutions provided in present disclosure allow efficient scheduling of PDSCH on multiple cells using a single DCI, with a clear and unambiguous HARQ feedback timing.

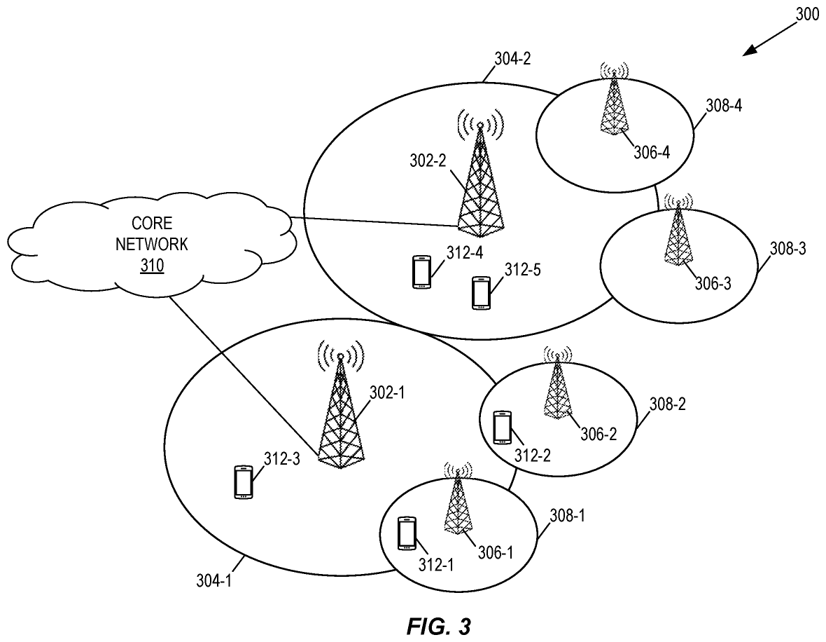

FIG. 3 illustrates one example of a cellular communications system 300 in which embodiments of the present disclosure may be implemented. In the embodiments described herein, the cellular communications system 300 is a 5G system (5GS) including a Next Generation RAN (NG-RAN) and a 5G Core (5GC); however, the embodiments disclosed herein are not limited to the 5GS. In this example, the RAN includes base stations 302-1 and 302-2, which in the 5GS include NR base stations (gNBs) and optionally next generation eNBs (ng-eNBs) (e.g., LTE RAN nodes connected to the 5GC), controlling corresponding (macro) cells 304-1 and 304-2. The base stations 302-1 and 302-2 are generally referred to herein collectively as base stations 302 and individually as base station 302. Likewise, the (macro) cells 304-1 and 304-2 are generally referred to herein collectively as (macro) cells 304 and individually as (macro) cell 304. The RAN may also include a number of low power nodes 306-1 through 306-4 controlling corresponding small cells 308-1 through 308-4. The low power nodes 306-1 through 306-4 can be small base stations (such as pico or femto base stations) or Remote Radio Heads (RRHs), or the like. Notably, while not illustrated, one or more of the small cells 308-1 through 308-4 may alternatively be provided by the base stations 302. The low power nodes 306-1 through 306-4 are generally referred to herein collectively as low power nodes 306 and individually as low power node 306. Likewise, the small cells 308-1 through 308-4 are generally referred to herein collectively as small cells 308 and individually as small cell 308. The cellular communications system 300 also includes a core network 310, which in the 5G System (5GS) is referred to as the 5GC. The base stations 302 (and optionally the low power nodes 306) are connected to the core network 310.

The base stations 302 and the low power nodes 306 provide service to wireless communication devices 312-1 through 312-5 in the corresponding cells 304 and 308. The wireless communication devices 312-1 through 312-5 are generally referred to herein collectively as wireless communication devices 312 and individually as wireless communication device 312. In the following description, the wireless communication devices 312 are oftentimes UEs and as such are sometimes referred to herein as UEs 312, but the present disclosure is not limited thereto.

Now, the description turns to details of some example embodiments of the present disclosure. DCI scheduling a single cell for downlink can be in DCI format DCI 1-0/1-1/1-2. DCI scheduling a single cell for uplink can be in DCI format DCI 0-0/0-1/0-2 for uplink. For convenience, DCI scheduling PDSCH on multiple cells is referred to herein as DCI 1-X.

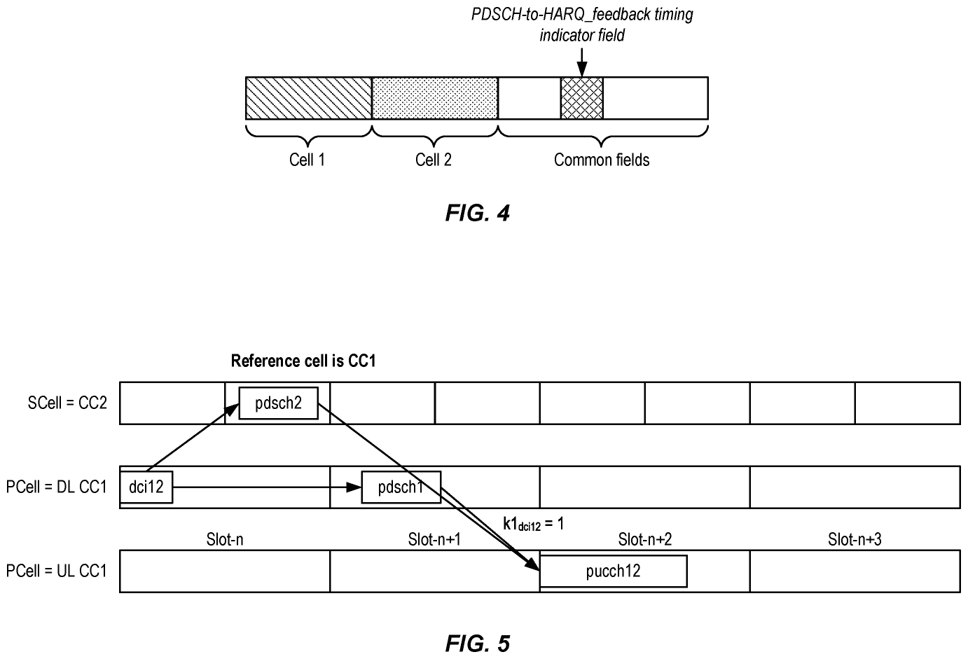

A UE 312 can be configured with multiple cells. For a cell of the multiple cells, the UE 312 can be configured to monitor one or more DCI scheduling a single cell and to monitor one or more DCI scheduling multiple cells. In DCI scheduling multiple cells, only a portion of the DCI may contain scheduling information relevant for each cell. An example of DCI scheduling PDSCH on multiple cells is shown in FIG. 4. The DCI schedules PDSCH on two cells (Cell1 and Cell2), and the DCI contains some fields that are applicable to cell 1 only, some fields that are applicable to cell 2 only, and some common fields. For example, the Modulation and Coding Scheme (MCS) and frequency domain resource allocation fields may be separate for each cell, while some fields such as PDSCH-to-HARQ_feedback timing indicator and PUCCH resource indictor can be a common field.

The embodiments below describe how to identify the HARQ feedback timing in case one DCI schedules PDSCH on multiple cells when the DCI contains a single PDSCH-to-HARQ_feedback timing indicator.

### Embodiment 1

In an embodiment, a UE 312 is configured with multiple cells and is configured to monitor one DCI format (e.g., DCI 1_X) scheduling PDSCH on multiple cells. The UE 312 is configured with a reference cell for PDSCH HARQ ACK timing. The reference cell can be a PCell or a SCell. The reference cell can be one of the cells for which PDSCH is scheduled via the DCI. When DCI scheduling PDSCH on multiple cells is received, the UE 312 determines the slot for transmission of the HARQ feedback for the PDSCHs relative to the slot in which the PDSCH of the reference cell ends. The determination of the slot for transmission of the HARQ feedback is further dependent on a single PDSCH-to-HARQ_feedback timing indicator field in the DCI scheduling the PDSCHs on multiple cells. The UE 312 decodes the PDSCHs and transmits the HARQ feedback on the uplink in the determined slot for transmission of the HARQ feedback.

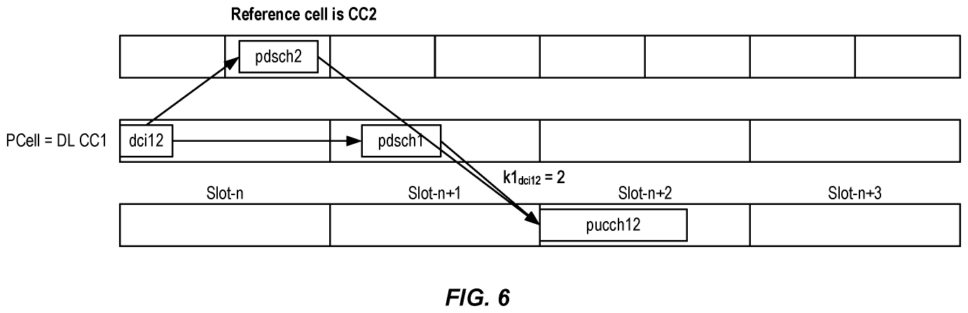

An example is shown in FIG. 5 where the reference cell is the PCell, which corresponds to Component Carrier (CC) CC1. Thus, the dci12 that schedules pdsch1 and pdsch2 on CC1 and CC2, respectively, includes a PDSCH-to-HARQ_feedback timing indicator field with value k1_{dci12}=1. Since the reference cell corresponds to CC1, the slot in which pdsch1 ends is given by n+1, and thus the HARQ feedback is transmitted in slot n+1+k1_{dci12}=slot n+2.

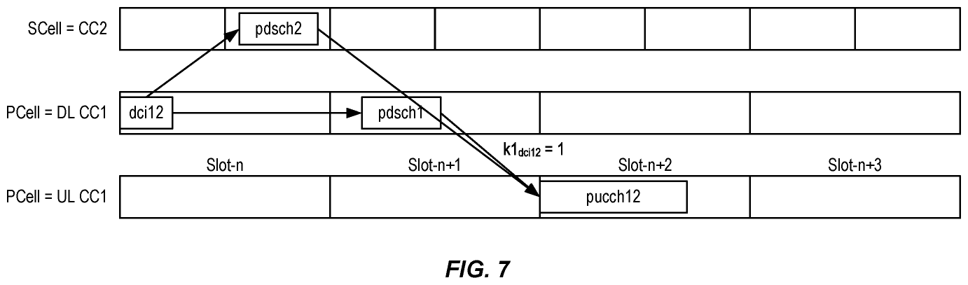

Another example is shown in FIG. 6 where the reference cell is the cell corresponding to CC2. Thus, the dci12 that schedules pdsch1 and pdsch2 on CC1 and CC2, respectively, include a PDSCH-to-HARQ_feedback timing indicator field with value k1_{dci12}=2. Since the reference cell corresponds to CC2, the slot in which pdsch2 ends is given by n, and thus the HARQ feedback is transmitted in slot n+k1_{dci12}=slot n+2.

An example UE procedure is as follows. With reference to slots for PUCCH transmissions, if the UE 312 detects a DCI format 1_X scheduling PDSCH reception on the reference serving cell ending in slot n, the UE 312 provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK. k=0 corresponds to the last slot of the PUCCH transmission that overlaps with the PDSCH reception on the reference serving cell.

In one embodiment, the reference cell is configured via higher layers (e.g., by Radio Resource Control (RRC) signaling). The reference cell can be explicitly configured as one of the cells for which PDSCH is scheduled via the single DCI scheduling PDSCHs on multiple cells. If the multi-cell DCI does not schedule the reference cell, a fallback solution is needed; in case the DCI only schedules a single cell, this cell would become the reference cell.

In one embodiment, a default reference cell can be defined. The default reference cell can be the cell where the DCI scheduling PDSCH on multiple cells is received. If the multi-cell DCI does not schedule the reference cell, a fallback solution is needed; in case the DCI only schedules a single cell, this cell would become the reference cell.

For example, if the DCI scheduling PDSCH on multiple cells is received on a PCell that schedules PDSCH on the PCell and an SCell, then the PCell can be the reference cell.

As another example, if the DCI scheduling PDSCH on multiple cells is received on an SCell that schedules the SCell and the PCell, then SCell can be the reference cell.

In one embodiment, the reference cell is defined based on, e.g. cell indices of the cells scheduled by the DCI. For example, in one embodiment, the reference cell is defined as the cell among the scheduled cells with the lowest (or highest, or another function of) cell index.

In another embodiment, the reference cell can be defined via its position in the scheduling DCI, e.g. the cell carrying the PDSCH which scheduling information occurs first (or last, or at another defined position) in the DCI is the reference cell.

### Embodiment 2

In an embodiment, a UE 312 is configured with multiple cells and is configured to monitor a DCI format (e.g., DCI 1_X) scheduling PDSCH on multiple cells. When DCI scheduling PDSCH on multiple cells is received, the UE 312 determines the slot for transmission of the HARQ feedback (for the PDSCHs) relative to a reference slot. The reference slot can be the slot in which the last-ending PDSCH of the multiple PDSCHs scheduled by the DCI ends. Note that the reference slot is counted according to the numerology of the cell which carries the last-ending PDSCH. The determination of the slot for transmission of the HARQ feedback is further dependent on a single PDSCH-to-HARQ_feedback timing indicator field in the DCI scheduling PDSCH on multiple cells. The UE 312 decodes the PDSCHs and transmits the HARQ feedback on the uplink in the determined slot for transmission of the HARQ feedback.

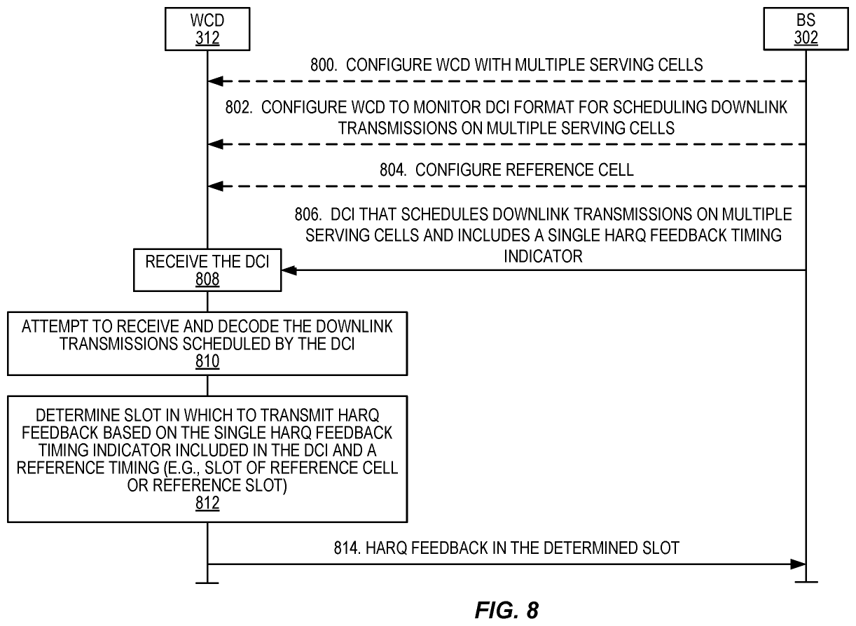

An example is shown in FIG. 7. The dci12 that schedules pdsch1 and pdsch2 on PCell corresponding to CC1 and SCell corresponding to CC2, respectively, include a PDSCH-to-HARQ_feedback timing indicator field with value k1_{dci12}=1. Since pdsch1 ends later than pdsch2, slot n+1 (of PCell corresponding to CC1) where pdsch1 ends, the reference slot is slot n+1. Thus, the HARQ feedback is transmitted in slot n+1+k1_{dci12}=slot n+2. Thus, the reference slot is slot in which the last PDSCH ends considering all PDSCHs scheduled by dci12.

An example UE procedure is as follows. With reference to slots for PUCCH transmissions, if the UE 312 detects a DCI format 1_X scheduling PDSCH receptions with the latest PDSCH reception ending in slot n, the UE 312 provides corresponding HARQ-ACK information in a PUCCH transmission within slot n+k, where k is a number of slots and is indicated by the PDSCH-to-HARQ_feedback timing indicator field in the DCI format, if present, or provided by dl-DataToUL-ACK. k=0 corresponds to the last slot of the PUCCH transmission that overlaps with last symbol of PDSCH reception across the cells scheduled by DCI format 1_X.

### ADDITIONAL DESCRIPTION

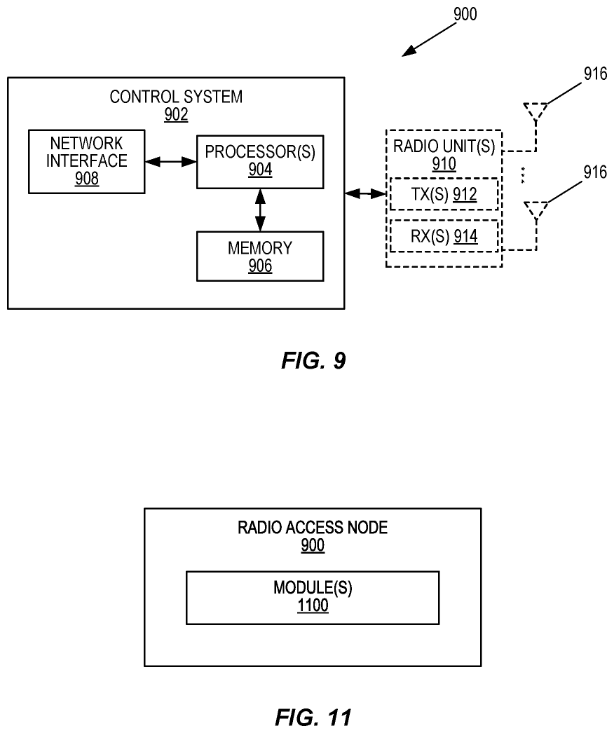

FIG. 8 illustrates the operation of a wireless communication device 312 and a base station 302 in accordance with at least some aspects of the embodiments described above. Optional steps are represented by dashed lines/boxes. As illustrated, the base station 302 configures the wireless communication device 312 with multiple serving cells (e.g., a PCell and an SCell) (step 800). The base station 302 also configures the wireless communication device 312 to monitor for DCI in a DCI format (e.g., DCI format 1_X) for scheduling downlink transmissions (e.g., PDSCHs) on multiple serving cells (step 802). Optionally, in some embodiments, the base station 302 configures the wireless communication device 312 with a reference cell for PDSCH-to-HARQ feedback timing (804). This configuration may be by higher layer signaling such as, e.g., RRC signaling. The base station 302 transmits a DCI (in the DCI format) that schedules downlink transmissions to the wireless communication device 312 on at least some of the multiple serving cells configured for the wireless communication device 312 (step 806). The DCI includes a single PDSCH-to-HARQ feedback timing indicator that is common for all of the scheduled downlink transmissions.

At the wireless communication device 312, the wireless communication device 312 receives the DCI (step 808) and attempts to receive and decode the downlink transmissions scheduled by the DCI (step 810). Note that attempting to receive and decode the downlink transmissions is also referred to herein simply as “receiving and decoding” the downlink transmissions, where this receiving and decoding may be successful or unsuccessful. In order to transmit HARQ feedback for the downlink transmission scheduled by the DCI, the wireless communication device 312 determines a slot in which to transmit the HARQ feedback for the downlink transmissions scheduled by the DCI based on the PDSCH-to-HARQ feedback timing indicator included in the DCI and a predefined or configured reference timing (step 812). As discussed above, in one embodiment, the reference timing is a slot in which the downlink transmission for a reference cell among the cells for which the downlink transmissions are scheduled by the DCI. The reference cell may be configured, e.g., in step 804 or predefined (e.g., by 3GPP specifications), as discussed above with respect to Embodiment 1. As also discussed above with respect to Embodiment 2, in another embodiment, the reference timing is a configured or predefined reference slot. As discussed above, the reference slot may be, for example, the slot in which the last-ending downlink transmission from among the downlink transmissions scheduled by the DCI ends. The wireless communication device 312 transmits HARQ feedback for the downlink transmissions scheduled by the DCI in the determined slot (step 814).

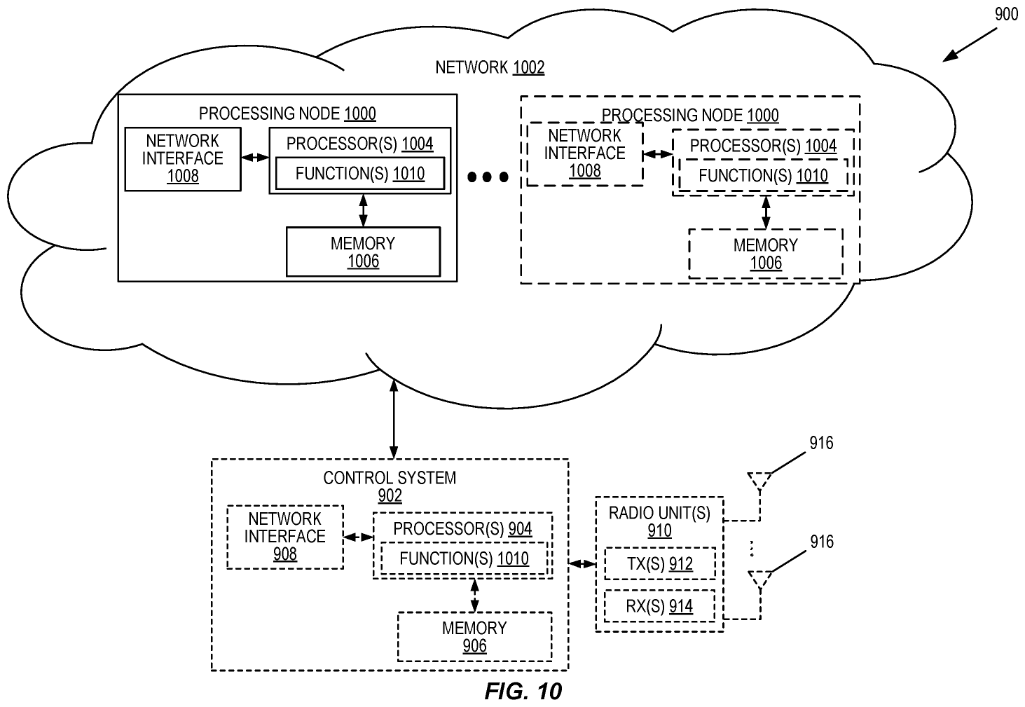

FIG. 9 is a schematic block diagram of a radio access node 900 according to some embodiments of the present disclosure. Optional features are represented by dashed boxes. The radio access node 900 may be, for example, a base station 302 or a network node that implements all or part of the functionality of the base station 302 described herein. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 may include one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of the radio access node 900 as described herein (e.g., one or more functions of the base station 302 described above, e.g., with respect to FIG. 8). In some embodiments, the function(s) are implemented in software that is stored, e.g., in the memory 906 and executed by the one or more processors 904.

FIG. 10 is a schematic block diagram that illustrates a virtualized embodiment of the radio access node 900 according to some embodiments of the present disclosure. As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 may include the control system 902 and/or the one or more radio units 910, as described above. The control system 902 may be connected to the radio unit(s) 910 via, for example, an optical cable or the like. The radio access node 900 includes one or more processing nodes 1000 coupled to or included as part of a network(s) 1002. If present, the control system 902 or the radio unit(s) are connected to the processing node(s) 1000 via the network 1002. Each processing node 1000 includes one or more processors 1004 (e.g., CPUs, ASICs, FPGAs, and/or the like), memory 1006, and a network interface 1008.

In this example, functions 1010 of the radio access node 900 described herein (e.g., one or more functions of the base station 302 described above, e.g., with respect to FIG. 8) are implemented at the one or more processing nodes 1000 or distributed across the one or more processing nodes 1000 and the control system 902 and/or the radio unit(s) 910 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein (e.g., one or more functions of the base station 302 described above, e.g., with respect to FIG. 8). This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

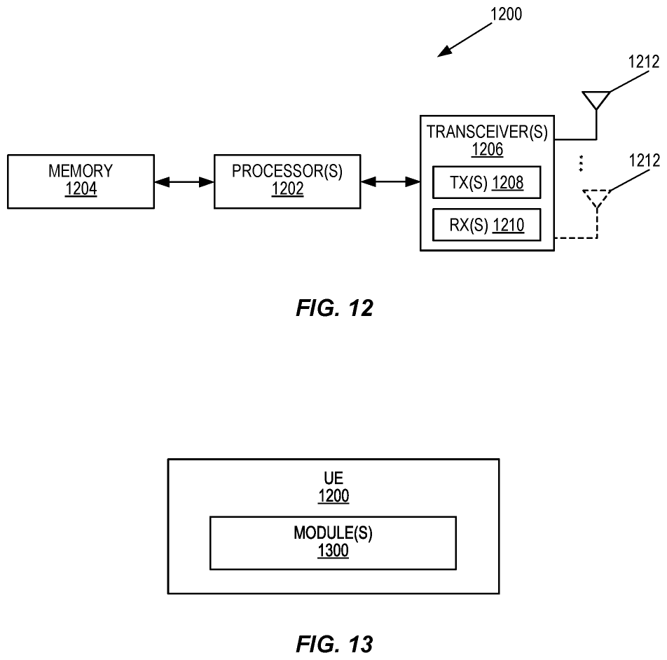

FIG. 12 is a schematic block diagram of a wireless communication device 1200 according to some embodiments of the present disclosure. The wireless communication device 1200 may be, for example, the wireless communication device 312/UE 312. As illustrated, the wireless communication device 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the wireless communication device 1200 described above (e.g., one or more functions of the wireless communication device 312/UE 312 described above, e.g., with respect to Embodiment 1, Embodiment 2, and FIG. 8) may be fully or partially implemented in software that is, e.g., stored in the memory 1204 and executed by the processor(s) 1202. Note that the wireless communication device 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the wireless communication device 1200 and/or allowing output of information from the wireless communication device 1200), a power supply (e.g., a battery and associated power circuitry), etc.

In some embodiments, a computer program including instructions which, when executed by at least one processor, causes the at least one processor to carry out the functionality of the wireless communication device 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the wireless communication device 1200 according to some other embodiments of the present disclosure. The wireless communication device 1200 includes one or more modules 1300, each of which is implemented in software. The module(s) 1300 provide the functionality of the wireless communication device 1200 described herein (e.g., one or more functions of the wireless communication device 312/UE 312 described above, e.g., with respect to Embodiment 1, Embodiment 2, and FIG. 8).

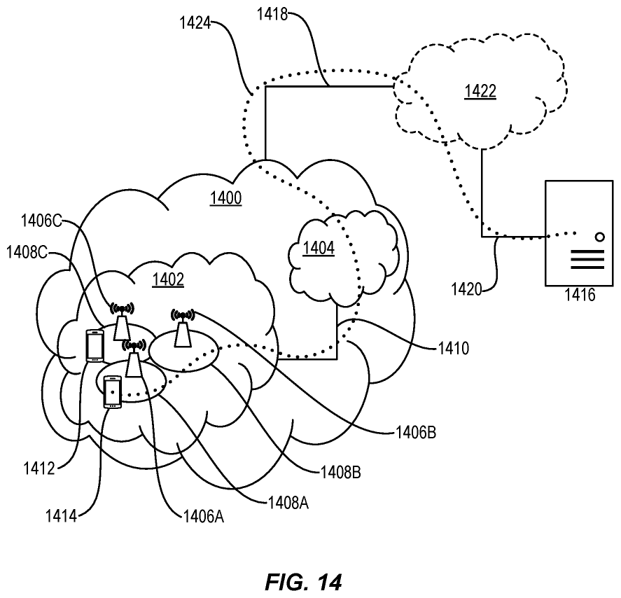

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as Node Bs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

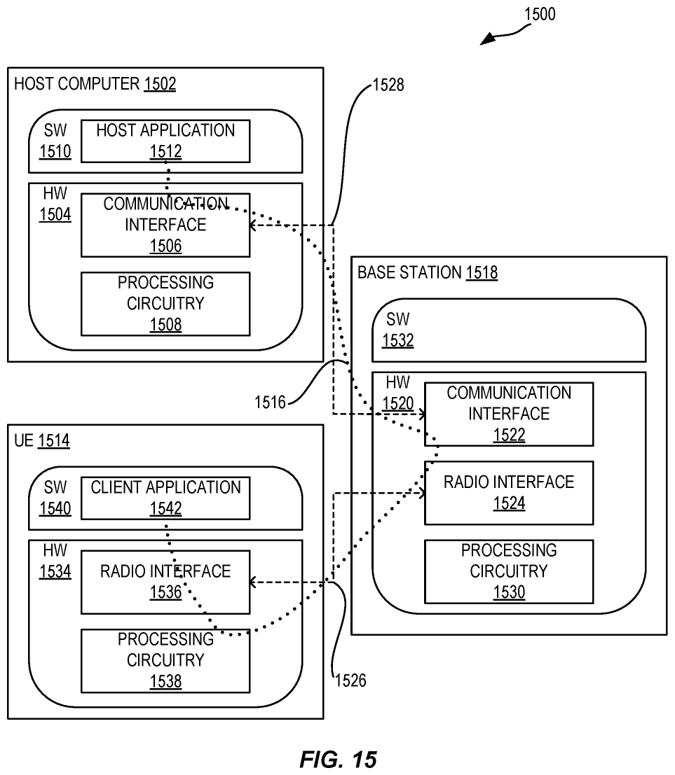

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502's measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

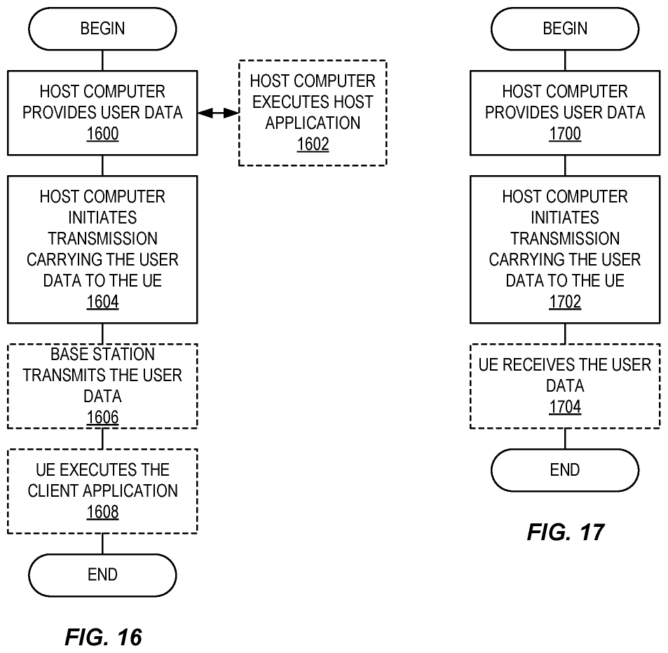

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

### Group A Embodiments

Embodiment 1: A method performed by a wireless communication device (312) for a cellular communications system (300), the method comprising: receiving (808), from a base station (302), a downlink control information, DCI, that schedules downlink transmissions to the wireless communication device (312) on two or more serving cells of the wireless communication device (312); attempting (810) to receive and decode the downlink transmissions scheduled by the DCI; determining (812) a slot in which to transmit Hybrid Automatic Repeat Request, HARQ, feedback for the downlink transmissions scheduled by the DCI based on a single HARQ feedback timing indicator comprised in the DCI and a reference timing; and transmitting (814), to the base station (302), HARQ feedback for the downlink transmissions scheduled by the DCI in the determined slot.
Embodiment 2: The method of embodiment 1 wherein the reference timing is a slot in which one of the downlink transmissions that is scheduled for a reference cell ends.
Embodiment 3: The method of embodiment 2 wherein the reference cell is one of the two or more serving cells for which the DCI schedules the downlink transmissions.
Embodiment 4: The method of embodiment 2 or 3 wherein the reference cell is configured by a network node in the cellular communications system (300).
Embodiment 5: The method of embodiment 2 or 3 further comprising receiving (804), from the base station (302), information that configures the reference cell.
Embodiment 6: The method of embodiment 5 wherein receiving (804) the information that configures the reference cell comprise receiving (804) the information that configures the reference cell via higher layer signaling (e.g., RRC signaling).
Embodiment 7: The method of embodiment 2 or 3 wherein the reference cell is predefined.
Embodiment 8: The method of embodiment 2 or 3 wherein the reference cell is one of the two or more serving cells on which the wireless communication device (312) receives the DCI.
Embodiment 9: The method of embodiment 2 or 3 wherein the reference cell is one of the two or more serving cells for which the DCI schedules the downlink transmissions that has a lowest cell index from among cell indices of the two or more serving cells.
Embodiment 10: The method of embodiment 2 or 3 wherein the reference cell is one of the two or more serving cells for which the DCI schedules the downlink transmissions that has a highest cell index from among cell indices of the two or more serving cells.
Embodiment 11: The method of embodiment 2 or 3 wherein the reference cell is one of the two or more serving cells for which the DCI schedules the downlink transmissions selected as a function (e.g., a predefined function) of cell indices of the two or more serving cells.
Embodiment 12: The method of any of embodiments 2 to 11 wherein the determined slot is slot X+Y, where X is the slot in which one of the downlink transmissions that is scheduled for a reference cell ends and Y is a number of slots indicated by the single HARQ feedback timing indicator comprised in the DCI.
Embodiment 13: The method of embodiment 1 wherein the reference timing is a reference slot.
Embodiment 14: The method of embodiment 13 wherein the reference slot is a slot in which a last-ending downlink transmission from among the downlink transmissions scheduled by the DCI ends.
Embodiment 15: The method of embodiment 14 wherein the reference slot is counted according to a numerology of one of the two or more serving cells that carries the last-ending downlink transmission.
Embodiment 16: The method of any of embodiments 13 to 15 wherein the determined slot is slot X+Y, where X is the reference slot and Y is a number of slots indicated by the single HARQ feedback timing indicator comprised in the DCI.
Embodiment 17: The method of any of embodiments 1 to 16 wherein the downlink transmissions are Physical Downlink Shared Channels, PDSCHs.
Embodiment 18: The method of any of embodiments 1 to 17 wherein at least two of the two or more serving cells use different numerologies.

### Group B Embodiments

Embodiment 19: A method performed by a base station (302) for a cellular communication system (300), the method comprising: transmitting (808), to a wireless communication device (30), a downlink control information, DCI, that schedules downlink transmissions to the wireless communication device (312) on two or more serving cells of the wireless communication device (312); receiving (814), from the wireless communication device (302), Hybrid Automatic Repeat Request, HARQ, feedback for the downlink transmissions scheduled by the DCI in a particular slot, wherein the particular slot is defined based on a single HARQ feedback timing indicator comprised in the DCI and a reference timing.
Embodiment 20: The method of embodiment 19 wherein the reference timing is a slot in which one of the downlink transmissions that is scheduled for a reference cell ends.
Embodiment 21: The method of embodiment 20 wherein the reference cell is one of the two or more serving cells for which the DCI schedules the downlink transmissions.
Embodiment 22: The method of embodiment 20 or 21 wherein the reference cell is configured by a network node in the cellular communications system (300).
Embodiment 23: The method of embodiment 20 or 21 further comprising transmitting (804), to the wireless communication device (302), information that configures the reference cell.
Embodiment 24: The method of embodiment 23 wherein transmitting (804) the information that configures the reference cell comprise transmitting (804) the information that configures the reference cell via higher layer signaling (e.g., RRC signaling).
Embodiment 25: The method of embodiment 20 or 21 wherein the reference cell is predefined.
Embodiment 26: The method of embodiment 20 or 21 wherein the reference cell is one of the two or more serving cells on which the wireless communication device (312) receives the DCI.
Embodiment 27: The method of embodiment 20 or 21 wherein the reference cell is one of the two or more serving cells for which the DCI schedules the downlink transmissions that has a lowest cell index from among cell indices of the two or more serving cells.
Embodiment 28: The method of embodiment 20 or 21 wherein the reference cell is one of the two or more serving cells for which the DCI schedules the downlink transmissions that has a highest cell index from among cell indices of the two or more serving cells.
Embodiment 29: The method of embodiment 20 or 21 wherein the reference cell is one of the two or more serving cells for which the DCI schedules the downlink transmissions selected as a function (e.g., a predefined function) of cell indices of the two or more serving cells.
Embodiment 30: The method of any of embodiments 20 to 29 wherein the particular slot is slot X+Y, where X is the slot in which one of the downlink transmissions that is scheduled for a reference cell ends and Y is a number of slots indicated by the single HARQ feedback timing indicator comprised in the DCI.
Embodiment 31: The method of embodiment 19 wherein the reference timing is a reference slot.
Embodiment 32: The method of embodiment 31 wherein the reference slot is a slot in which a last-ending downlink transmission from among the downlink transmissions scheduled by the DCI ends.
Embodiment 33: The method of embodiment 32 wherein the reference slot is counted according to a numerology of one of the two or more serving cells that carries the last-ending downlink transmission.
Embodiment 34: The method of any of embodiments 31 to 33 wherein the particular slot is slot X+Y, where X is the reference slot and Y is a number of slots indicated by the single HARQ feedback timing indicator comprised in the DCI.
Embodiment 35: The method of any of embodiments 19 to 34 wherein the downlink transmissions are Physical Downlink Shared Channels, PDSCHs.
Embodiment 36: The method of any of embodiments 19 to 35 wherein at least two of the two or more serving cells use different numerologies.
Embodiment 37: The method of any of the previous embodiments, further comprising: obtaining user data; and forwarding the user data to a wireless communication device.

### Group C Embodiments

Embodiment 38: A wireless communication device comprising: processing circuitry configured to perform any of the steps of any of the Group A embodiments; and power supply circuitry configured to supply power to the wireless communication device.
Embodiment 39: A base station comprising: processing circuitry configured to perform any of the steps of any of the Group B embodiments; and power supply circuitry configured to supply power to the base station.
Embodiment 40: A User Equipment, UE, comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.
Embodiment 41: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.
Embodiment 42: The communication system of the previous embodiment further including the base station.
Embodiment 43: The communication system of the previous 2 embodiments, further including the UE, wherein the UE is configured to communicate with the base station.
Embodiment 44: The communication system of the previous 3 embodiments, wherein: the processing circuitry of the host computer is configured to execute a host application, thereby providing the user data; and the UE comprises processing circuitry configured to execute a client application associated with the host application.
Embodiment 45: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.
Embodiment 46: The method of the previous embodiment, further comprising, at the base station, transmitting the user data.
Embodiment 47: The method of the previous 2 embodiments, wherein the user data is provided at the host computer by executing a host application, the method further comprising, at the UE, executing a client application associated with the host application.
Embodiment 48: A User Equipment, UE, configured to communicate with a base station, the UE comprising a radio interface and processing circuitry configured to perform the method of the previous 3 embodiments.
Embodiment 49: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.
Embodiment 50: The communication system of the previous embodiment, wherein the cellular network further includes a base station configured to communicate with the UE.
Embodiment 51: The communication system of the previous 2 embodiments, wherein: the processing circuitry of the host computer is configured to execute a host application, thereby providing the user data; and the UE's processing circuitry is configured to execute a client application associated with the host application.
Embodiment 52: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.
Embodiment 53: The method of the previous embodiment, further comprising at the UE, receiving the user data from the base station.
Embodiment 54: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.
Embodiment 55: The method of the previous embodiment, further comprising at the base station, receiving the user data from the UE.
Embodiment 56: The method of the previous 2 embodiments, further comprising at the base station, initiating a transmission of the received user data to the host computer.

Those skilled in the art will recognize improvements and modifications to the embodiments of the present disclosure. All such improvements and modifications are considered within the scope of the concepts disclosed herein.

1. A method performed by a wireless communication device operable in a cellular communications system, the method comprising:
receiving, from a base station, a downlink control information (DCI) that schedules downlink transmissions to the wireless communication device on two or more serving cells of the wireless communication device;
receiving and decoding the downlink transmissions on the two or more serving cells scheduled by the DCI;
determining a slot in which to transmit Hybrid Automatic Repeat Request (HARQ) feedback for the downlink transmissions on the two or more serving cells scheduled by the DCI based on a single HARQ feedback timing indicator comprised in the DCI and a reference timing; and
transmitting, to the base station, HARQ feedback for the downlink transmissions on the two or more serving cells scheduled by the DCI in the determined slot.

2. The method of claim 1 wherein the reference timing is a slot in which one of the downlink transmissions that is scheduled for a reference cell ends.

3. The method of claim 2 wherein the reference cell is one of the two or more serving cells for which the DCI schedules the downlink transmissions.

4. The method of claim 2 wherein the reference cell is configured by a base station in the cellular communications system.

5. The method of claim 2 further comprising receiving, from the base station, information that configures the reference cell.

6. The method of claim 5 wherein receiving the information that configures the reference cell comprise receiving the information that configures the reference cell via higher layer signaling.

7. The method of claim 2 wherein the reference cell is predefined.

8. The method of claim 2 wherein the reference cell is one of the two or more serving cells on which the wireless communication device receives the DCI.

9. The method of claim 2 wherein the reference cell is one of the two or more serving cells for which the DCI schedules the downlink transmissions that has a lowest cell index from among cell indices of the two or more serving cells.

10. The method of claim 2 wherein the reference cell is one of the two or more serving cells for which the DCI schedules the downlink transmissions that has a highest cell index from among cell indices of the two or more serving cells.

11. The method of claim 2 wherein the reference cell is one of the two or more serving cells for which the DCI schedules the downlink transmissions selected as a function of cell indices of the two or more serving cells.

12. The method of claim 1 wherein the determined slot is slot X+Y, where X is the slot in which one of the downlink transmissions that is scheduled for a reference cell ends and Y is a number of slots indicated by the single HARQ feedback timing indicator comprised in the DCI.

13. The method of claim 2 wherein the reference cell is one of the two or more serving cells for which the DCI schedules the downlink transmissions defined by a position in which corresponding scheduling information occurs in the DCI.

14. The method of claim 1 wherein the reference timing is a reference slot.

15. The method of claim 14 wherein the reference slot is a slot in which a last-ending downlink transmission from among the downlink transmissions scheduled by the DCI ends.

16. The method of claim 15 wherein the reference slot is counted according to a numerology of one of the two or more serving cells that carries the last-ending downlink transmission.

17. The method of claim 14 wherein the determined slot is slot X+Y, where X is the reference slot and Y is a number of slots indicated by the single HARQ feedback timing indicator comprised in the DCI.

18. The method of claim 1 wherein the downlink transmissions are Physical Downlink Shared Channels (PDSCHs).

19. The method of claim 1 wherein at least two of the two or more serving cells use different numerologies.

20. A wireless communication device for a cellular communication system, the wireless communication device adapted to:
receive, from a base station, a downlink control information (DCI) that schedules downlink transmissions to the wireless communication device on two or more serving cells of the wireless communication device;
receive and decode the downlink transmissions on two or more serving cells scheduled by the DCI;
determine a slot in which to transmit Hybrid Automatic Repeat Request (HARQ) feedback for the downlink transmissions on two or more serving cells scheduled by the DCI based on a single HARQ feedback timing indicator comprised in the DCI and a reference timing; and
transmit, to the base station, HARQ feedback for the downlink transmissions on two or more serving cells scheduled by the DCI in the determined slot.

21. (canceled)

22. A wireless communication device for a cellular communication system, the wireless communication device comprising:
one or more transmitters;
one or more receivers; and
processing circuitry associated with the one or more transmitters and the one or more receivers, the processing circuitry configured to cause the wireless communication device to:
receive, from a base station, a downlink control information (DCI) that schedules downlink transmissions to the wireless communication device on two or more serving cells of the wireless communication device;
receive and decode the downlink transmissions on two or more serving cells scheduled by the DCI;
determine a slot in which to transmit Hybrid Automatic Repeat Request (HARQ) feedback for the downlink transmissions on two or more serving cells scheduled by the DCI based on a single HARQ feedback timing indicator comprised in the DCI and a reference timing; and
transmit, to the base station, HARQ feedback for the downlink transmissions on two or more serving cells scheduled by the DCI in the determined slot.

23-45. (canceled)
